(19) United States
(12) Patent Application Publication
(10) Pub. No.: US 2026/0310653 A1
(43) Pub. Date: Oct. 8, 2026

(54) TECHNIQUES TO ENSURE VECTOR PROVENANCE

(71) Applicant: Red Hat, Inc., Raleigh, NC (US)

(72) Inventors: Robert GEADA, Newcastle Upon Tyne (GB); Alex CREASY, Newcastle Upon Tyne (GB)

(21) Appl. No.: 19/170,447

(22) Filed: Apr. 4, 2025

(51) Int. Cl. G06F 16/23

(52) U.S. Cl. CPC G06F 16/2365

(57) ABSTRACT

A vector comprising a set of bits and corresponding to a multi-dimensional embedding space may be identified. Provenance data may be generated. A processing device may encode the provenance data in a subset of the set of bits of the vector corresponding to the multi-dimensional embedding space to produce an encoded vector.

### TECHNICAL FIELD

Aspects of the present disclosure relate to techniques to ensure vector provenance and, more particularly, to provenance data encoded into vectors in a multi-dimensional embedding space.

### BACKGROUND

An embedding space may refer to an embedding of a set of items within a manifold in which objects (e.g., documents) resembling each other are positioned closer to one another. Position within the embedding space can be viewed as being defined by a set of latent variables that emerge from the resemblances from the objects. The values for the set of latent variables may define a vector in the embedding space corresponding to the object.

Retrieval-Augmented Generation (RAG) is a technique that grants generative artificial intelligence models information retrieval capabilities. It modifies interactions with a large language model (LLM) so that the model responds to user queries with reference to a specified set of documents, using this information to augment information drawn from its own vast, static training data. In RAG, each document in the specified set of documents may be embedded into a multi-dimensional embedding space, which may be represented as a vector. This can allow LLMs to use domain-specific and/or updated information. For example, RAG may be utilized for include providing chatbot access to internal company data or giving factual information only from an authoritative source.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIGS. 1A and 1B illustrate an exemplary operating environments for ensuring vector provenance according to some embodiments of the present disclosure.

FIGS. 2A-2D illustrate various aspects of vectors in a multi-dimensional embedding space and provenance data according to some embodiments of the present disclosure.

FIG. 3 illustrates a process flow for utilizing a provenance applicator and a provenance validator to ensure vector provenance according to some embodiments of the present disclosure.

FIG. 4 illustrates a flow diagram of a method for a provenance applicator according to some embodiments of the present disclosure.

FIG. 5 illustrates a block diagram of an example system for encoding a vector with provenance data according to some embodiments of the present disclosure.

FIG. 6 illustrates a block diagram of an example system according to some embodiments of the present disclosure.

### DETAILED DESCRIPTION

The following description sets forth numerous specific details such as examples of specific systems, components, methods, and so forth, in order to provide a good understanding of various embodiments of the techniques described herein for ensuring vector provenance. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Many embodiments included herein are described with respect to retrieval augmented generation (RAG) and/or large language model (LLM) frameworks. It will be appreciated, however, that the techniques disclosed hereby are not limited in this context and can be generally applied to any system that relies upon or leverages vectors in a multi-dimensional embedding space without departing from the scope of this disclosure.

RAG can include a technique used during LLM deployments, wherein a supply of trusted, truthful documents are used as reference materials for the LLM to consult whilst responding to user queries. This may be done to minimize the occurrence of LLM hallucinations (the production of false information within an LLM response), which in turn provides trust that the LLM output is reliable. The typical RAG architecture includes a vector store containing vectorized representations of reference documents. Each document in the vector store is an n-dimensional vector, the direction of which encodes the semantic and informational contents of the corresponding document. It is akin to an arrow from the origin that points at some region on the surface of an n-dimensional hypercube. For example, a vector corresponding to a document may point at a region for “technical references that described specific commands within the Docker CLI” or recipes for cooking an authentic spaghetti Bolognese”. The utility of these document vectors is that nearby vectors correspond to nearby concepts. The ‘nearbyness’ of two vectors is measured by the cosine similarity of the two, which describes how aligned in direction the two vectors are. However, RAG can only be utilized to increase LLM reliability if the document vectors within the vector store itself are reliable.

More generally, existing systems that rely of vectors in a multi-dimensional embedding space (e.g., RAG and/or LLM) fail to provide mechanisms to ensure that the vectors have not been manipulated, such as by malicious actors. For example, a bad actor may be able to gain access to a vector-store and artificially insert documents containing facts or falsehoods according to some malicious intent, such as false information about a rival political candidate. Some existing systems may modify token output distribution of LLMs for LLM watermarking. This existing technique biases the model to produce certain detectable key phrases, but the information content that can be encoded is extraordinarily limited. Adding further complexity, in a distributed system, both the vector store and the LLM itself may lie behind different opaque endpoints. This makes it impractical or impossible for existing systems to verify the authenticity of messages coming from these endpoints, ensure the provenance of reference material (e.g., in a RAG), and later verify which documents were referenced by a RAG system and their provenance. These limitations can drastically reduce the security and reliability of systems, contributing to limited applicability, undependable performance, and systems, devices, and techniques with limited capabilities.

Accordingly, many embodiments disclosed hereby provide various techniques and features for ensuring vector provenance. For example, various embodiments may apply minor perturbations to vectors to encode provenance data within the vectors. In some embodiments, this technique may be applied to multiple message channels within a RAG architecture. For example, provenance data may be applied to both the vector store (e.g., RAG vectors) and the LLM outputs (e.g., LLM pre-embedding responses). In various embodiments, these techniques can be utilized to verifying the authenticity of messages coming from different opaque endpoints. Further, the provenance and the vector (e.g., document vector) may be inseparable, such as to enable provenance to be confirmed at anytime. In several embodiments, the original vector size is unmodified, resulting in no additional storage costs to ensure provenance or outwardly noticeable indications of the provenance to uninformed parties. Further, the vector and its provenance may be intrinsically combined into a single inseparable object, rending tampering of the provenance or original vector immediately obvious. For example, the provenance of each document in a vector store can be indelibly and inseparably encoded into the document vector itself, which prevents the insertion of malicious reference materials. In another example, the provenance of each LLM response, as well as the list of reference materials and their corresponding provenances that informed the response, can be indelibly and inseparably encoded into the response itself, preventing falsification of LLM outputs and enabling auditability of responses.

In these and other ways, components/techniques described hereby may provide many technical advantages for ensuring vector provenance. For example, incorporation and verification of vector provenance can be reliably and efficiently implemented. Therefore, the computer-based techniques of the current disclosure improve the functioning of computer systems, resulting in better security and improved capabilities as compared to conventional approaches. Therefore, embodiments disclosed hereby can be practically utilized to improve the functioning of a computer and/or to improve a variety of technical fields including data provenance, security, RAG, LLM, and vector stores.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

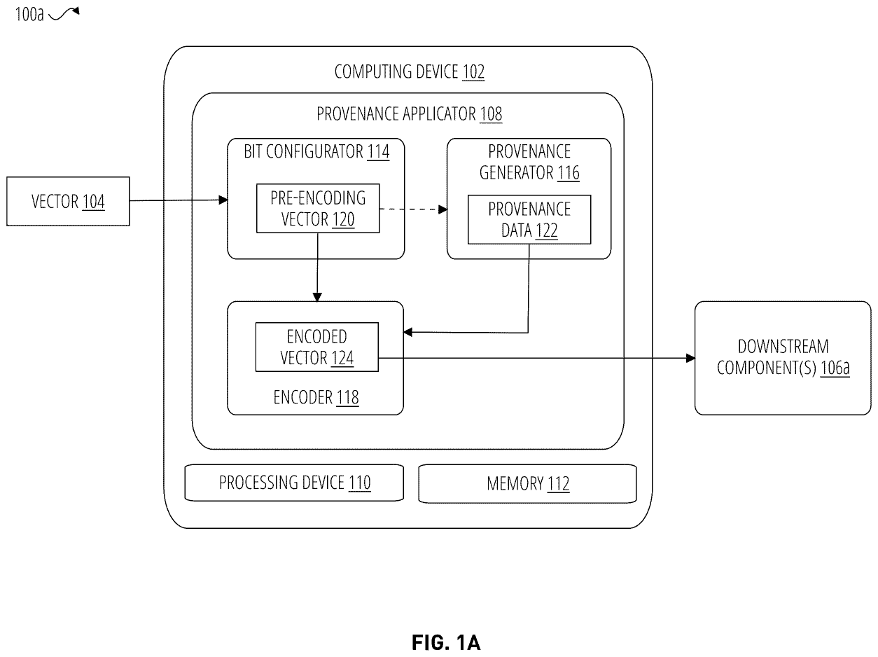

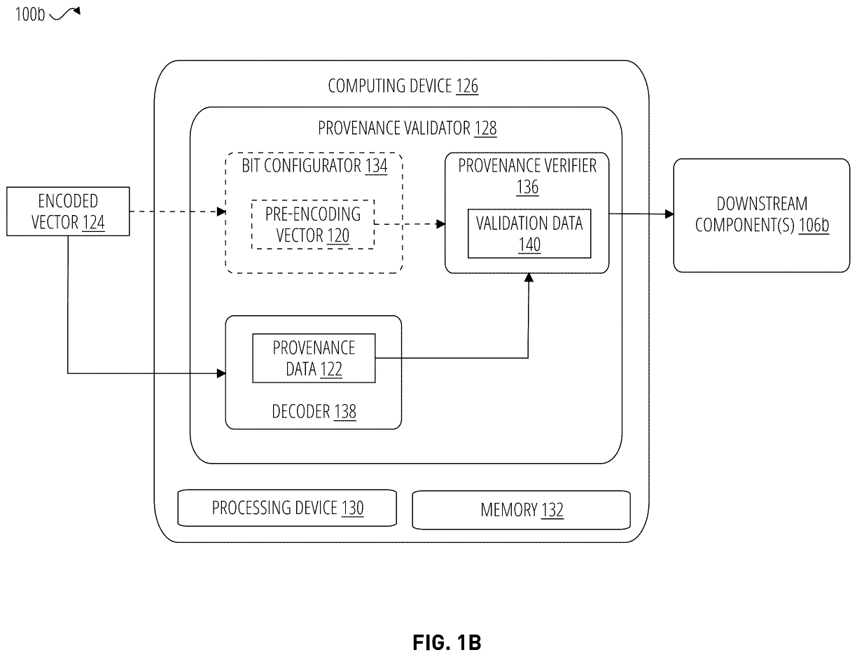

FIGS. 1A and 1B illustrate an exemplary operating environments 100a, 100b for ensuring vector provenance according to some embodiments. More specifically, the operating environment 100a of FIG. 1A includes a provenance applicator 108 for encoding provenance data 122 in a vector 104 and the operating environment 100b includes a provenance validator 128 for verifying provenance data 122 in an encoded vector 124. The provenance data 124 may provide a signature or fingerprint in the encoded vector 124 that can be utilized to verify the authenticity of the encoded vector 124. In some embodiments, the provenance data 124 may be generated based, at least in part, on the vector 104. In alternative, or additional, embodiments, the provenance data may be based on data not included in the vector 104. One or more components of FIGS. 1A and 1B may be the same or similar to one or more other components disclosed hereby. For example, bit configurator 114 may be the same or similar to bit configurator 134. Further, aspects discussed with respect to various components in FIGS. 1A and 1B may be implemented by one or more other components from one or more other embodiments without departing from the scope of this disclosure. For example, provenance applicator 108 and provenance validator 128 may be implemented by computing device 102 without departing from the scope of this disclosure. Embodiments are not limited in this context.

Referring to FIG. 1A, operating environment 100a includes computing device 102, vector 104, and one or more downstream components 106a. In the illustrated embodiment, the computing device 102 includes a provenance applicator 108, a processing device 110, and a memory 112. The provenance applicator 108 includes a bit configurator 114, a provenance generator 116, and an encoder 118. The provenance applicator 108 may apply minor perturbations to vectors to encode provenance information (e.g., provenance data 122) into the vectors and generally operate as follows. The bit configurator 114 may generate a pre-encoding vector 120 based on vector 104. The pre-encoding vector 120 may include the vector 104 with a specific set of bits erased or cleared (set to zero). This specific set of bits may ultimately be utilized to encode provenance data into the vector. In various embodiments, the specific set of bits (e.g., locations in vector 104) may be predefined and/or set by an administrator. In various such embodiments, the specific set of bits may be selected to limit the degradation of the utility of the vector 104, such as by including low significance bits. In several embodiments, the specific set of bits may be determined based on one or more characteristics of the system, such as the provenance data generation algorithm (e.g., cryptographic hash, etc.), parameters of the multi-dimensional embedding space (e.g., number of dimensions, etc.), parameters of the vector (e.g., number of elements, number of bits, etc.). Knowledge of the specific set of bits (e.g., locations in vector 104) may be shared between the provenance applicator 108 and the provenance validator 128.

The provenance data 122 may be generated, or obtained, by the provenance generator 116. The provenance data 122 may be of any origin. For example, the provenance data 122 may be, or be based on, predefined and/or set by an administrator (e.g., a secret code). In some such examples, the provenance data 122 may include a hash of provenance information that is predefined and/or set by an administrator. In many embodiments, the pre-encoding vector 120 may be passed to the provenance generator 116 for generation of provenance data 122. For example, provenance generator 116 may hash the pre-encoding vector 120 to generate the provenance data 122. Further, the encoder 118 may combine the pre-encoding vector 120 and the provenance data 122 to generate an encoded vector 124. In various embodiments, the encoded vector 124 may comprise the pre-encoding vector 120 with the provenance data 122 encoded into the specific set of bits erased from the vector 104. The encoded vector 124 may then be passed to one or more downstream components 106a. For example, the encoded vector 124 may be stored in a vector store. In some embodiments, the vector 104 may be retrieved from the vector store and replaced with the encoded vector 124. In one embodiments, the encoded vector 124 may be generated based on the vector 104 immediately after generation of the vector (e.g., by an embedding model) and then stored in the vector store.

It should be noted that although a single processing device 110 and a single memory 112 are depicted in the computing device 102 of FIG. 1A for simplicity, other embodiments may include multiple processing devices, storage devices, or devices. Processing device 110 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 110 may also include one or more special-purpose processing devices such as an application specific integrated circuit (ASIC), a field programmable gate array (FPGA), a digital signal processor (DSP), network processor, or the like.

In one embodiment, the provenance applicator 108 may implement the following exemplary algorithm with the following givens: (1) a set of vectors (including vector 104) within a vector store of dimensionality, N, with every element in the range [0, 1); (2) a function P(V) for generating a provenance message of size D for a give vector, V (e.g., a 512-bit signed hash of V); and (3) an identifying index for each document within the store (e.g., an embedding in a multi-dimensional space). The exemplary algorithm may proceed as follows. The number of bits to perturb per vector in the vector store may be determined based on P=max(1, D/N). The number of elements to perturb per vector may be determined based on E=D if D<N else N. Next, the following operations may be performed on each vector, V, in the vector store. Select E elements within the vector for perturbation. For example, this could be the first E elements, or for additional security it could be according to some selection process pre-established between the creators of the vector store and LLM (e.g., the first E even-indexed elements, or E elements indexed by the Fibonacci sequence, etc.). Then, for each element e within the E selected elements, P low-significance bits may be selected. In some embodiments, the specific choice of P may be different for each element (e.g., based on pre-established process). A vector V′ (e.g., pre-encoding vector 120) may be created by erasing the P selected bits from each of the E selected elements. A provenance message (e.g., provenance data 122) may be created from P(V′). The provenance message may be written into the erased bits within V′ to create V″ (e.g., encoded vector 124). Finally, V may be overwritten with V″ in the vector store.

Referring to FIG. 1B, operating environment 100b includes computing device 126, encoded vector 124, and one or more downstream components 106b. In the illustrated embodiment, the computing device 126 includes a provenance validator 128, a processing device 130, and a memory 132. The provenance validator 128 includes a provenance verifier 136 and a decoder 138. In some embodiments, the provenance validator 128 includes a bit configurator 134, such as for when the provenance data 122 is generated based on the vector 104.

The provenance validator 128 may extract and validate provenance information in encoded vectors generally. In several embodiments, the provenance verifier 136 may generate one or more notifications or alerts and/or effect operation of one or more downstream components 106b based on a failure to validate provenance information. For example, if provenance information of a vector cannot be validated (e.g., does not match), then the provenance verifier 136 may prevent utilization of the vector and/or generate an administrator alert. In various embodiments, the provenance validator 128 may generally operate as follows.

The decoder 138 may generate provenance data 122 based on the encoded vector 124. For example, provenance data 122 may be decoded from the specific set of bits utilized by provenance applicator 108 to encode it. In some embodiments, the bit configurator 134 may generate the pre-encoding vector 120 based on the encoded vector 124. For example, the bit configurator 134 may recover the pre-encoding vector 120 by clearing the same specific set of bits erased by bit configurator 114. In some embodiments, generation of the pre-encoding vector 120 and provenance data 122 may be performed in a combined operation, such as using clear on read operations.

The provenance verifier 136 may compare the provenance data 122 to the validation data 140 to verify the provenance of the encoded vector 124. For example, when provenance data 122 is the same as validation data 140, the provenance of the encoded vector is verified. The validation data 140 may be generated or obtained using the same technique as the provenance generator 116. For example, the validation data 140 may be, or be based on, predefined and/or set by an administrator (e.g., a secret code). In some such examples, the provenance data 122 may include a hash of provenance information that is predefined and/or set by an administrator. Thus, as long as the validation data 140 is generated based on the same provenance information and the same procedure as the provenance data 122, the encoded vector 124 may be verified.

In various embodiments, such as when the provenance data 122 is generated based on vector 104, the provenance verifier 136 may generate validation data 140 based on the pre-encoding vector 120. For example, the validation data 140 may include a hash of the pre-encoding vector 120. The validation data 140 may then be compared to provenance data 122. When the validation data 140 matches the provenance data 122, the provenance is validated, but when the validation data 140 fails to match the provenance data 122, validation of the provenance fails. Based on this determination, provenance validator 128 may generate one or more alerts and/or effect operation of one or more of the downstream components 106b. For example, provenance validator 128 may prevent the encoded vector 124 from being utilized to generate a prompt for an LLM.

It should be noted that although a single processing device 110 and a single memory 112 are depicted in the computing device 102 of FIG. 1A for simplicity, other embodiments may include multiple processing devices, storage devices, or devices. Processing device 110 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 110 may also include one or more special-purpose processing devices such as an application specific integrated circuit (ASIC), a field programmable gate array (FPGA), a digital signal processor (DSP), network processor, or the like.

Continuing with the exemplary algorithm described above, when the LLM queries the vector store, the provenance message, P (e.g., provenance data 122), within each retrieved vector, V″ (e.g., encoded vector 124), is retrieved and decoded. If P does not match the expected message (e.g., if the encoded hash does not match the hash of the retrieved V′ (e.g., pre-encoding vector 120) or there is no retrievable message) the vector is rejected and the system administrators are alerted to possible tampering. If P matches the expectation, the vector is accepted and the RAG flow continues as normal.

In one exemplary implementation, the vector-store vectors may have 256 elements and the provenance data generator, P(V), is a SHA-256 hash of V, digitally signed with a certificate (e.g., ed25519) and padded to 256 bits. Encoding the 256-bit provenance data may involve perturbing the least significant bit of each element within a vector, effectively truncating each element to a float63 and appending a single provenance data bit. However, since this corresponds to a numeric change of just +/−5d−324 per element, the original semantic encoding of the document vector is unchanged, and can be consumed by the LLM without any meaningful change in performance.

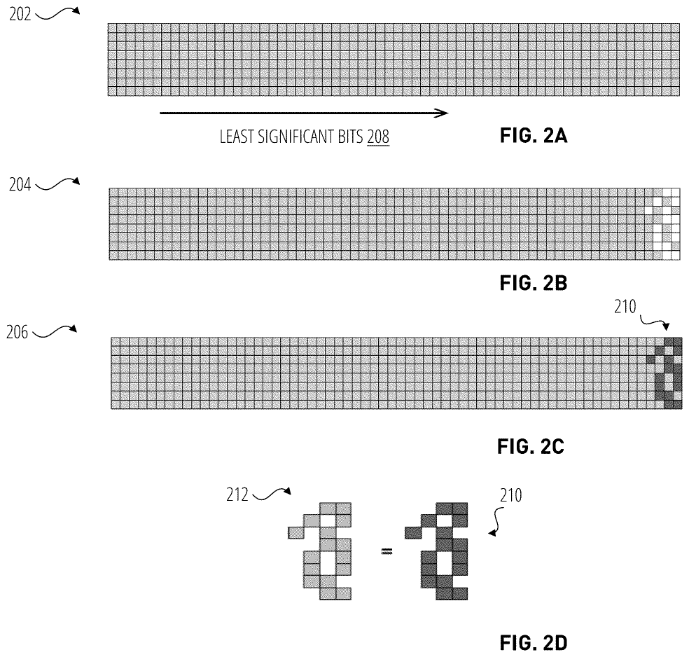

FIGS. 2A-2D illustrate various aspects of vectors in a multi-dimensional embedding space and provenance data according to some embodiments. More specifically, FIG. 2A illustrates a vector 202, FIG. 2B illustrates a pre-encoding vector 204, FIG. 2C illustrates an encoded vector 206 with provenance data 210, and FIG. 2D illustrates the provenance data 210 in conjunction with a validation data 212. One or more components of FIGS. 2A-2D may be the same or similar to one or more other components disclosed hereby. For example, vector 202, pre-encoding vector 204, and encoded vector 206, and provenance data 210 may be the same or similar to vector 104, pre-encoding vector 120, encoded vector 124, and provenance data 122, respectively. Further, aspects discussed with respect to various components in FIGS. 2A-2D may be implemented by one or more other components from one or more other embodiments without departing from the scope of this disclosure. Embodiments are not limited in this context.

Referring to FIG. 2A, the vector 202 may correspond to a multi-dimensional embedding space and include a set of bits with each box corresponding to a bit in the set of bits. In some embodiments, the vector 202 may comprise a vectorized representation of a reference document. In the illustrated embodiment, the set of bits of the vector 202 may comprise eight rows (or elements) with each row comprising 64 bits corresponding to a value in the vector 202. For example, each row may include a floating-point value for a dimension in the multi-dimensional embedding space. In one embodiment, each row of vector 202 may include a double-precisions floating-point value. Accordingly, the multi-dimensional embedding space for vector 202 may include eight dimensions with each of the eight values corresponding to a location in one dimension of the multi-dimensional embedding space. It will be appreciated that more or less dimensions and/or more or less bits for each dimension may be utilized without departing from the scope of this disclosure. In some embodiments, over a thousand dimensions may be used. In the illustrated embodiment, the least significant bits 208 are illustrated on the right side. In various embodiments, only bits with lower significance (e.g., the 4 columns next to the right side) may be perturbed to encode provenance data.

Referring to FIG. 2B, the pre-encoding vector 204 may include the portion of the vector 202 upon which the provenance data 210 is generated. In many embodiments, the pre-encoding vector 204 may include vector 202 with the specific set of bits for encoding the provenance data cleared. As discussed above, the specific set of bits may be predefined or determined based on a predefined process.

Referring to FIG. 2C, the encoded vector 206 may include the pre-encoding vector 204 with provenance data 210 stored in the specific set of bits. In several embodiments, provenance data 210 may include a hash of pre-encoding vector 204. For example, provenance data 210 may include a 512-bit signed hash of the pre-encoding vector 204.

Referring to FIG. 2D, the provenance data 210 may be verified by generating pre-encoding vector 204 based on encoded vector 206 and hashing the pre-encoding vector 204 to produce validation data 212. Accordingly, validation data 212 can be compared to provenance data 210 to validate the provenance of the encoded vector 206.

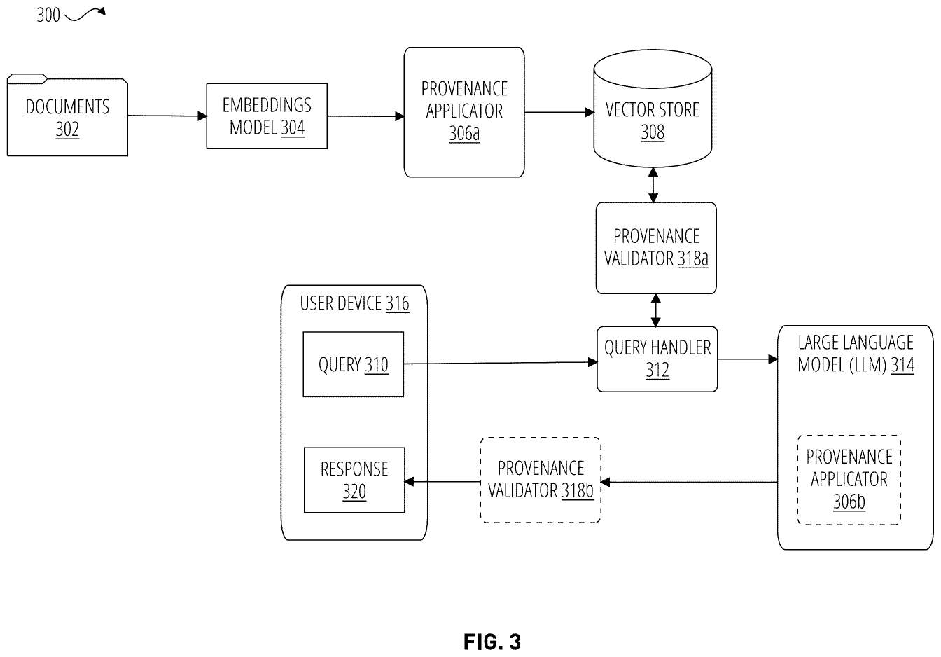

FIG. 3 illustrates a process flow 300 for utilizing provenance applicators 306a, 306b and provenance validators 318a, 318b to ensure vector provenance according to some embodiments. For example, process flow 300 may correspond to ensuring provenance of vectors in a retrieval-augmented generation (RAG) and/or LLM deployment. One or more components of FIG. 3 may be the same or similar to one or more other components disclosed hereby. For example, provenance applicator 306a and provenance validator 318a may be the same or similar to provenance applicator 108 and provenance validator 128, respectively. Further, aspects discussed with respect to various components in FIG. 3 may be implemented by one or more other components from one or more other embodiments without departing from the scope of this disclosure. For example, provenance applicator 306a and provenance validator 318a may be implemented by computing device 102 and provenance applicator 306b and provenance validator 318b may be implemented by computing device 126 without departing from the scope of this disclosure. In another example, provenance applicator 306b and/or provenance validator 318b may be excluded without departing from the scope of this disclosure. Embodiments are not limited in this context.

In process flow 300, each document in a set of documents 302 may be passed to an embeddings model 304. The embeddings model may generate a document vector in a multi-dimensional embedding space based on each document. The provenance applicator 306a may then generate an encoded vector based on the document vector, such as described above. The encoded vector may be stored in vector store 308.

Subsequently, a query 310 may be submitted to a query handler 312. The query handler 312 may utilize RAG to obtain relevant context from the vector store 308. The provenance validator 318a may verify the provenance of each vector retrieved from the vector store 308 as part of this process. In various embodiments, provenance validator 318a may only pass vectors that have been verified to the query handler 312. The query handler 312 may then utilize the retrieved and validated vectors along with the query 310 to generate an input to LLM 314 and the response 320 generated by the LLM 314 may be returned to the user device 316.

Optionally, provenance applicator 306b may be included, such as in LLM 314, to apply provenance data to the LLM 314 outputs, which can be validated downstream by one or more provenance validators 318b. For example, the provenance application/validations described above may be applied to the raw output vectors of the LLM 314. Typically, an LLM will return raw “tokens” (e.g., words) in response to a query. However, these tokens are internally represented via a token vector (e.g., some high-dimensional vector that encodes that token's specific contextual meaning). Much like described above, provenance data can be encoded into that vector by some minimal perturbation. In this case the token vectors may be significantly higher dimensionality than the document vectors (e.g., tens of thousands of dimensions) and every LLM response will contain many dozens or hundreds of tokens, providing hundreds of thousands or millions of total message bits. Accordingly, perturbing just a small fraction of these to preserve the semantic content of the response, there is room for more provenance data. This additional space may be utilized to encode additional provenance data, such as a has of the original LLM response, the provenance data of the documents referenced in the vector store, and/or the document identifiers of each referenced document within the RAG process. After the provenance data is encoded into the token vector, the full token vector may be returned to the caller (e.g., user device 316), rather than the final token itself.

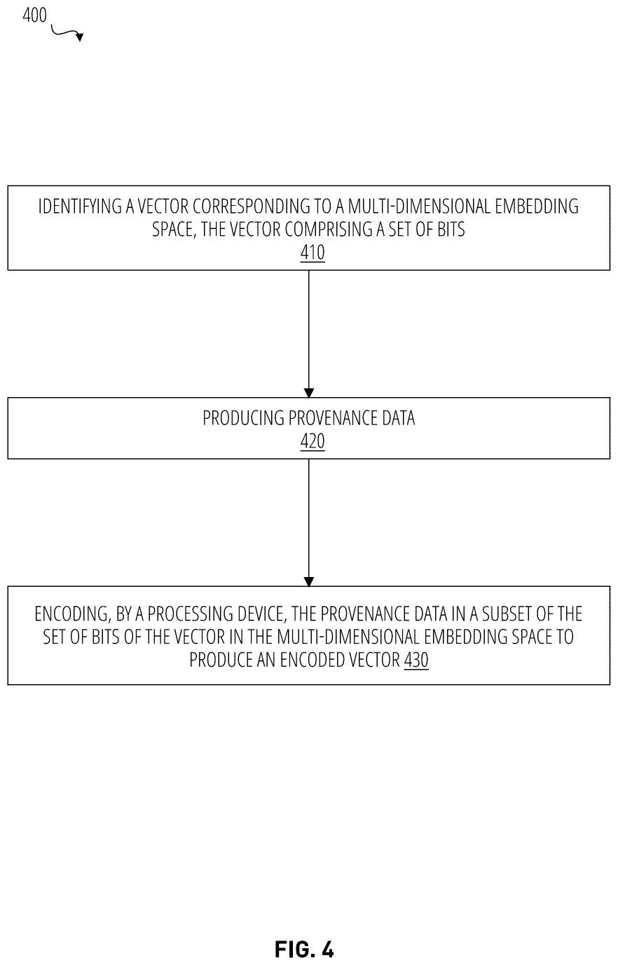

FIG. 4 is a flow diagram of a method 400 for a provenance applicator according to some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed through the execution of components in computing device 102, by processing device 110 of FIG. 1A and/or execution of components in computing device 126, by processing device 130. Embodiments are not limited in this context.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic identifies a vector corresponding to a multi-dimensional embedding space and including a set of bits. For example, provenance applicator 108 may identify vector 202. In some embodiments, the vector 202 may be identified by provenance applicator 108 subsequent to the vector 202 being output by an embeddings model. In other embodiments, the vector 202 may be identified by provenance applicator 108 subsequent to being retrieved from a vector store.

Proceeding to block 420, the processing logic may produce provenance data. For example, provenance generator 116 may produce the provenance data 122 by retrieving and/or hashing a secret code. In some embodiments, the provenance data may be generated based on a portion of the set of bits of the vector corresponding to the multi-dimensional embedding space. For example, provenance generator 116 may generate provenance data 210 based on the portion of vector 202 included in pre-encoding vector 204. As previously described, this portion may correspond to the vector 202 with a specific set of bits cleared.

Continuing to block 430, the processing logic may encode the provenance data in a subset of the set of bits of the vector in the multi-dimensional embedding space to produce an encoded vector. For example, encoder 118 may produce encoded vector 206 by encoding provenance data 210 into the specific bits cleared in pre-encoding vector 204.

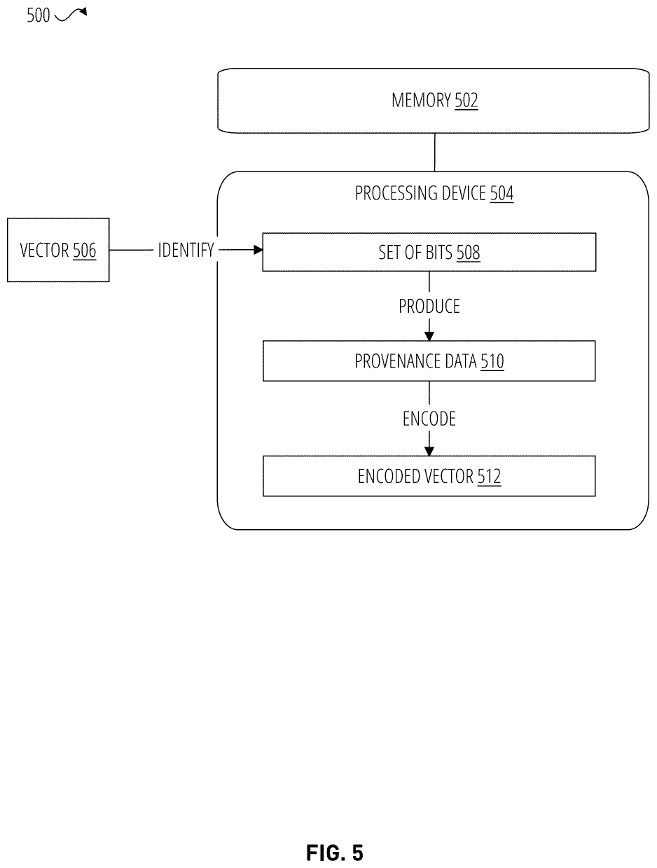

FIG. 5 illustrates a block diagram of a system 500 for encoding a vector with provenance data according to some embodiments. In the illustrated embodiment, system 500 includes a memory 502, a processing device 504, a vector 506, a set of bits 508, provenance data 510, and an encoded vector 512. It should be noted that some components of system 500 are shown for illustrative purposes only and are not physical components of the system 500, such as vector 506. One or more components of FIG. 5 may be the same or similar to one or more other components disclosed hereby. For example, processing device 504 may be the same or similar to processing device 110. Further, aspects discussed with respect to various components in FIG. 5 may be implemented by one or more other components from one or more other embodiments without departing from the scope of this disclosure. For example, at least a portion of vector 506, set of bits 508, provenance data 510, and/or encoded vector 512 may be included in memory 502 without departing from the scope of this disclosure. Embodiments are not limited in this context.

In system 500, the processing device 504 may identify a vector 506 corresponding to a multi-dimensional embedding space. The vector 506 may include a set of bits 508. The processing device 504 may produce provenance data 510, such as based on a portion of the set of bits 508. The processing device may then encode the provenance data 510 in a subset of the set of bits 508 to produce the encoded vector 512.

In various embodiments, generating the provenance data 510 includes hashing the portion of the set of bits (e.g., pre-encoding vector 204). In some embodiments, generating the provenance data 510 may include erasing values of the subset of the set of bits of the vector corresponding to the multi-dimensional embedding space to produce a pre-encoding vector (e.g., pre-encoding vector 204) and generating the provenance data based on the pre-encoding vector. In some such embodiments, encoding the provenance data in the subset of the set of bits includes storing the provenance data as values of the subset of the set of bits in the pre-encoding vector to produce the encoded vector. In many embodiments, the vector corresponds to an embedding of a document produced for a vector store in RAG. In many embodiments, the vector is generated by an artificial intelligence model, such as an embeddings model. In some embodiments, the encoded vector may be stored in a vector store for RAG. In various embodiments, the subset of the set of bits of the vector corresponding to the multi-dimensional embedding space encoding the provenance data includes one or more least significant bits in one or more elements of the set of bits.

In several embodiments, the encoded vectors 512 may be identified in response to a query for a LLM. In several such embodiments, the provenance data of the encoded vector may be validated and, in response to the validation, at least a portion of the encoded vector may be utilized to generate an input prompt for the LLM. In some further embodiments, the provenance data may include first provenance data and an output vector including a set of bits and generated by the LLM based on the input prompt for the LLM may be identified. Second provenance data may be generated based on a portion of the set of bits of the output vector generated by the LLM and the second provenance data may be encoded into a subset of the set of bits corresponding to the output vector generated by the LLM to produce an encoded output vector.

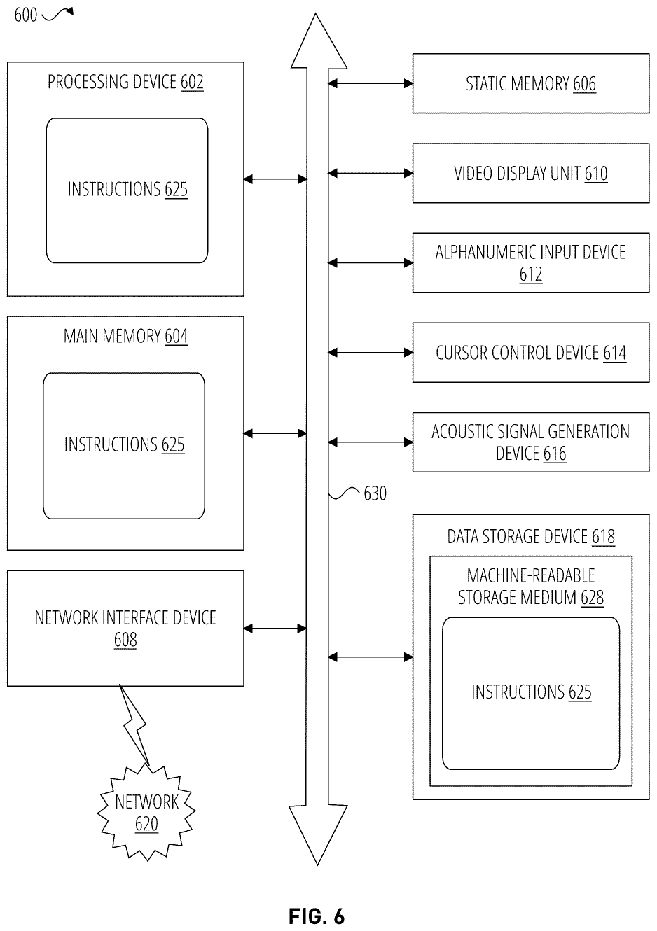

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device 602 (e.g., a general purpose processor, a PLD, etc.), a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a machine-readable storage medium 628 on which may be stored one or more sets of instructions 625 that may include instructions for a component (e.g., one or more components of provenance applicators 108, 306a, 306b, provenance verifiers 136, 318a, 318b, and/or downstream components 106a, 106b) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “identifying,” “generating,” “encoding,” “clearing,” “validating,” “utilizing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
identifying a vector corresponding to a multi-dimensional embedding space, the vector comprising a set of bits;
producing provenance data; and
encoding, by a processing device, the provenance data in a subset of the set of bits of the vector corresponding to the multi-dimensional embedding space to produce an encoded vector.

2. The method of claim 1, wherein the provenance data is produced based on a portion of the set of bits of the vector corresponding to the multi-dimensional embedding space.

3. The method of claim 2, wherein producing the provenance data includes hashing the portion of the set of bits.

4. The method of claim 1, further comprising:
clearing values of the subset of the set of bits of the vector corresponding to the multi-dimensional embedding space to produce a pre-encoding vector.

5. The method of claim 4, wherein the provenance data is produced based on the pre-encoding vector.

6. The method of claim 4, wherein encoding the provenance data in the subset of the set of bits includes storing the provenance data as values of the subset of the set of bits in the pre-encoding vector to produce the encoded vector.

7. The method of claim 1, wherein the vector corresponds to an embedding of a document produced for a vector store in retrieval-augmented generation.

8. The method of claim 1, further comprising:
identifying the encoded vector in response to a query for a large language model (LLM);
validating the provenance data of the encoded vector; and
utilizing at least a portion of the encoded vector to generate an input prompt for the LLM in response to validating the provenance data of the encoded vector.

9. The method of claim 8, wherein the provenance data includes a first provenance data and further comprising:
identifying an output vector generated by the LLM, the output vector generated based on the input prompt for the LLM, and the output vector comprising a set of bits;
generating a second provenance data based on a portion of the set of bits of the output vector generated by the LLM; and
encoding the second provenance data in a subset of the set of bits corresponding to the output vector generated by the LLM to produce an encoded output vector.

10. The method of claim 1, wherein the vector is generated by an artificial intelligence model.

11. The method of claim 1, further comprising storing the encoded vector in a vector store for retrieval-augmented generation.

12. The method of claim 1, wherein the subset of the set of bits of the vector corresponding to the multi-dimensional embedding space encoding the provenance data includes one or more least significant bits in one or more elements of the set of bits.

13. A system comprising:
a memory; and
a processing device, operatively coupled to the memory, to:
identify a vector corresponding to a multi-dimensional embedding space, the vector comprising a set of bits;
produce provenance data; and
encode, by a processing device, the provenance data in a subset of the set of bits of the vector corresponding to the multi-dimensional embedding space to produce an encoded vector.

14. The system of claim 13, wherein the provenance data is produced based on a portion of the set of bits of the vector corresponding to the multi-dimensional embedding space.

15. The system of claim 14, wherein to produce the provenance data the processing device is further to hash the portion of the set of bits.

16. The system of claim 15, wherein to produce the provenance data the processing device is further to:
clear values of the subset of the set of bits of the vector corresponding to the multi-dimensional embedding space to produce a pre-encoding vector; and
produce the provenance data based on the pre-encoding vector.

17. The system of claim 16, wherein to encode the provenance data in the subset of the set of bits the processing device is further to store the provenance data as values of the subset of the set of bits in the pre-encoding vector to produce the encoded vector.

18. A non-transitory computer-readable storage medium including instructions that, when executed by a processing device, cause the processing device to:
identify a vector corresponding to a multi-dimensional embedding space, the vector comprising a set of bits;
produce provenance data; and
encode, by a processing device, the provenance data in a subset of the set of bits of the vector corresponding to the multi-dimensional embedding space to produce an encoded vector.

19. The non-transitory computer-readable storage medium of claim 18, wherein the instructions, when executed by the processing device, further cause the processing device to:
identify the encoded vector in response to a query for a large language model (LLM);
validate the provenance data of the encoded vector; and
utilize at least a portion of the encoded vector to generate an input prompt for the LLM in response to validating the provenance data of the encoded vector.

20. The non-transitory computer-readable storage medium of claim 19, wherein the provenance data includes a first provenance data and the instructions, when executed by the processing device, further cause the processing device to:
identify an output vector generated by the LLM, the output vector generated based on the input prompt for the LLM, and the output vector comprising a set of bits;
produce a second provenance data based on a portion of the set of bits of the output vector generated by the LLM; and
encode the second provenance data in a subset of the set of bits corresponding to the output vector generated by the LLM to produce an encoded output vector.
